(19) United States
(12) Patent Application Publication
(10) Pub. No.: US 2017/0219193 A1
(43) Pub. Date: Aug. 3, 2017

(54) Electronic lamp holder with improved structure

(71) Applicant: Shucheng Xingyuan Houseware Co., Ltd., Liu'an City (CN)

(72) Inventor: Quan Tang, Shenzhen (CN)

(21) Appl. No.: 15/139,142

(22) Filed: Apr. 26, 2016

(30) Foreign Application Priority Data
Jan. 29, 2016 (CN) 201620106042.8

(51) Int. Cl. F21V 23/02; F21V 3/00; F21V 17/06; F21V 23/04

(52) U.S. Cl. CPC F21V 23/023; F21V 23/04; F21V 3/00; F21V 17/06

(57) ABSTRACT

An electronic lamp holder with an improved structure includes a lamp holder whose upper part protrudes upwards to form a loading part, a battery mounting bin is designed in the loading part, a bin cover is on the bottom surface of the lamp holder for covering the battery mounting bin; a luminous body and a circuit board and a button switch for controlling the same are arranged on the loading part; the edge of the lamp holder extends upwards to form a blocking edge part and extends towards the outside to form a blocking part, a cylindrical locating sleeve is on the blocking edge part, an axle hole penetrating the locating sleeve is formed in the middle, a notch is formed in the outside face of the locating sleeve, a locating piece is arranged in the axle hole of the locating sleeve and rotates around the axle hole.

### FIELD OF THE UTILITY MODEL

The utility model relates to the technical field of lighting devices, and in particular, to an electronic lamp holder with an improved structure.

### BACKGROUND OF THE UTILITY MODEL

With the increasing improvement of living standards of Chinese residents, and with the improvement of the economic level and decoration level, the demands on crafts are increased, meanwhile, the crafts slowly develop towards artistry, energy saving and intelligence, and in all the crafts, lighting crafts can be widely used in home lighting, hotels, commerce and the like and are well welcomed by people.

The existing decorative lamps are generally formed by assembling luminous bodies with modeling lampshades, and then connecting the modeling lampshades with lamp holders, so that the assembly is troublesome, labor-wasting and time-wasting.

Referring to the Chinese patent ZL200520062283.9 entitled novel decorative lamp published on Oct. 25, 2006, the technical contents of the patent are as follows: a hollow inner cavity is formed in the modeling lampshade, the luminous body is arranged in the inner cavity, then the lamp holder and the lampshade are integrally formed by injection molding or an adhesive at a modeling lampshade embedding opening and the tail end of an electric wire, so as to fix the components, but it is very troublesome to assemble the lamp holder provided with the luminous body with the lampshade, the production efficiency is low, and disassembly and maintenance are inconvenient.

### SUMMARY OF THE UTILITY MODEL

The technical problem to be solved by the utility model is to provide an electronic lamp holder with an improved structure, which is convenient to assemble and disassemble, low in use cost and convenient to maintain.

The technical problem to be solved by the utility model is realized by the following technical solution:

an electronic lamp holder with an improved structure includes a lamp holder, an upper part of the lamp holder protrudes upwards to form a loading part, a battery mounting bin for mounting a battery is designed in the loading part, a bin cover is arranged on the bottom surface of the lamp holder, and the bin cover is used for covering the battery mounting bin; a luminous body and a circuit board and a button switch used for controlling the luminous body are arranged on the loading part; and the edge of the lamp holder extends upwards to form a blocking edge part, the edge of the lamp holder extends towards the outer side to form a blocking part, a cylindrical locating sleeve is arranged on the blocking edge part, an axle hole penetrating through the locating sleeve is formed in the middle of the locating sleeve, a notch is formed in the outer side face of the locating sleeve, a locating piece is arranged in the axle hole of the locating sleeve, and the locating piece can rotate around the axle hole.

A gap is formed in a position located on the left side of the notch on the upper edge opening of the locating sleeve, and protection edges integrated with the blocking edge part are arranged on both sides of the notch to combine the locating sleeve with the blocking edge part.

The locating piece includes a locating screw, a locating cap is connected to an upper end of the locating screw, a clamping stop dog is arranged on the locating cap, and the clamping stop dog and the locating cap are vertical and are integrally formed; and a reinforcing rib is connected between the clamping stop dog and the locating cap, so that the clamping stop dog has a very good supporting force.

The clamping stop dog can be clamped in the gap, the locating cap is inserted into the axle hole of the locating sleeve, the upper end of the locating screw penetrates through the lamp holder to stretch into the axle hole to be connected in the locating cap through threads, and a cross slotted head is arranged at a lower end of the locating screw.

The button switch is arranged on the bottom surface of the lamp holder, the button switch is connected with the circuit board, and the circuit board is connected with the battery.

The lamp holder is a circular lamp holder, the blocking edge part is arranged along the circumferential direction of the lamp holder, the loading part is located on the inner side of the blocking edge part, and the loading part is designed to a square structure to conveniently mount the battery.

Three or four groups of locating sleeves are provided, if four groups of locating sleeves are provided, the four groups of locating sleeves are arranged in a square to form four supporting points, and if three groups of locating sleeves are provided, the three groups of locating sleeves are arranged in a triangle to completely support the lamp holder.

An electronic lamp includes a lampshade, a circular mounting opening is formed in the bottom of the lampshade, a clamping edge is arranged on the edge of the mounting opening towards the interior of the lampshade, a lamp holder is mounted in the mounting opening, an upper part of the lamp holder protrudes upwards to form a loading part, a battery mounting bin for mounting a battery is designed in the loading part, a bin cover is arranged on the bottom surface of the lamp holder, and the bin cover is used for covering the battery mounting bin; a luminous body and a circuit board and a button switch used for controlling the luminous body are arranged on the loading part; and the edge of the lamp holder extends upwards to form a blocking edge part, the edge of the lamp holder extends towards the outer side to form a blocking part, a cylindrical locating sleeve is arranged on the blocking edge part, an axle hole penetrating through the locating sleeve is formed in the middle of the locating sleeve, a notch is formed in the outer side face of the locating sleeve, a locating piece is arranged in the axle hole of the locating sleeve, and the locating piece can rotate around the axle hole.

The lamp holder is made of a plastic material or other lightweight insulating materials; and the shape of the lampshade can be designed according to demands, the material can also be selected according to demands, for example, glass, ceramic, plastic, wood, metal or the like, as long as the requirements of the lampshade are satisfied, therefore the selection range is wide and the adaptability is good.

During assembly, the lamp holder is directly clamped in the mounting opening in the bottom of the lampshade, the blocking edge part is in contact with the inner wall of the lampshade, the blocking part is propped on the bottom surface of the lampshade, at this time, the clamping stop dog is located on the gap at the upper part of the locating sleeve, the locating screw is rotated clockwise, the locating screw drives the locating cap to rotate, when rotating to the notch on the locating sleeve, the locating cap drops along the axle hole, the locating cap is located by the limitation of the notch, so that the clamping stop dog on the locating cap is clamped on the clamping edge in the lampshade to connect the lamp holder with the lampshade, and then the locating screw is fastened; and during disassembly, the locating screw is rotated counterclockwise, the locating screw is partially separated from the locating cap, at this time, the locating cap is jacked up to make the clamping stop dog on the locating cap be flush with the gap, the clamping stop dog is rotated counterclockwise to locate the clamping stop dog on the gap of the locating sleeve, so as to make the lamp holder drop off relative to the lampshade, and then the lamp holder can be taken off.

The utility model has the beneficial effects that the utility model changes the connection mode of the traditional lamp holder, after the above technical solution is adopted, the lamp holder is very convenient to be mounted and disassembled, and the luminous component is changed more simply and can be cooperatively used with a variety of lampshades, therefore the production cost is reduced, and the service life is prolonged.

### BRIEF DESCRIPTION OF THE DRAWINGS

FIG. 1 is a structure diagram of a lamp holder of the utility model;

FIG. 2 is an assembly diagram of the utility model when a locating piece is clamped;

FIG. 3 is a structure diagram of the locating piece of the utility model;

FIG. 4 is an assembly diagram of the locating piece and a gap on the lamp holder of the utility model;

FIG. 5 is a view of the bottom of the lamp holder of the utility model;

FIG. 6 is a structure diagram of an electronic lamp provided by the utility model.

### DETAILED DESCRIPTION OF THE EMBODIMENTS

In order that the technical means realizing the utility model, the creation characteristics, the purposes and effects are more understandable, the utility model will be further illustrated below in combination with specific drawings.

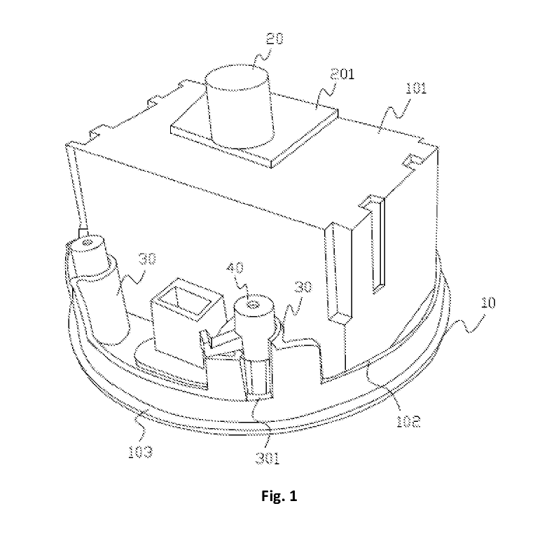

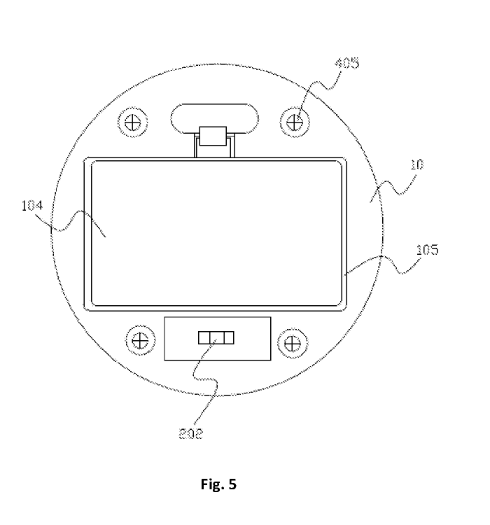

As shown in FIG. 1 and FIG. 5, an electronic lamp holder with an improved structure includes a lamp holder 10, an upper part of the lamp holder 10 protrudes upwards to form a loading part 101, a battery mounting bin 105 for mounting a battery is designed in the loading part 101, a bin cover 104 is arranged on the bottom surface of the lamp holder 10, and the bin cover 104 is used for covering the battery mounting bin 105; a luminous body 20 and a circuit board 201 and a button switch 202 used for controlling the luminous body 20 are arranged on the loading part 101; the button switch 202 is arranged on the bottom surface of the lamp holder 10, the button switch 202 is connected with the circuit board 201, the circuit board 201 is connected with the battery, and the luminous body 20 is connected to the circuit board 201; and the edge of the lamp holder 10 extends upwards to form a blocking edge part 102, the edge of the lamp holder 10 extends towards the outer side to form a blocking part 103, a cylindrical locating sleeve 30 is arranged on the blocking edge part 102, an axle hole penetrating through the locating sleeve 30 is formed in the middle of the locating sleeve 30, a notch 301 is formed in the outer side face of the locating sleeve 30, a locating piece 40 is arranged in the axle hole of the locating sleeve 30, and the locating piece 40 can rotate around the axle hole.

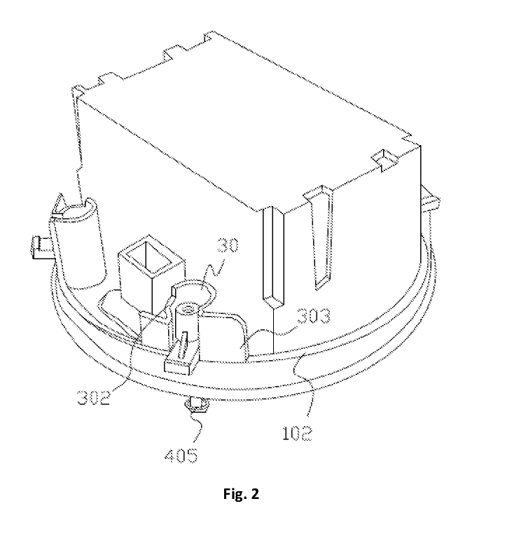

As shown in FIG. 2, a gap 302 is formed in a position located on the left side of the notch 301 on the upper edge opening of the locating sleeve 30, protection edges 303 integrated with the blocking edge part 102 are arranged on both sides of the notch 301 to combine the locating sleeve 30 with the blocking edge part 102, the formation is very convenient, meanwhile the overall strength is relatively high, and the long-term use requirements are satisfied.

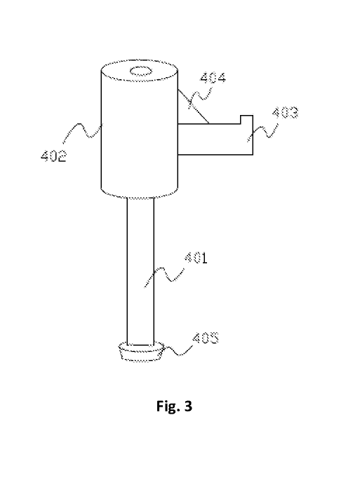

As shown in FIG. 3, the locating piece 40 includes a locating screw 401, a locating cap 402 is connected to an upper end of the locating screw 401, a screw hole is formed in the middle of the locating cap 402, the locating screw 401 is connected in the screw hole and can be connected quickly, a clamping stop dog 403 is arranged on the locating cap 402, and the clamping stop dog 403 and the locating cap 402 are vertical and are integrally formed; and a reinforcing rib 404 is connected between the clamping stop dog 403 and the locating cap 402, so that the clamping stop dog 403 has a very good supporting force.

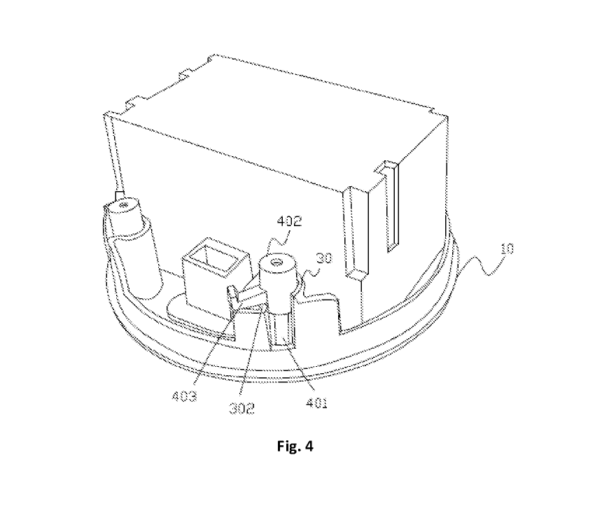

As shown in FIG. 4, the clamping stop dog 403 can be clamped in the gap 302, the locating cap 402 is inserted into the axle hole of the locating sleeve 30, the upper end of the locating screw 401 penetrates through the lamp holder 10 to stretch into the axle hole to be connected in the locating cap 402 through threads, and a cross slotted head 405 is arranged at a lower end of the locating screw 401.

As shown in FIG. 1, the lamp holder 10 is a circular lamp holder, the blocking edge part 102 is arranged along the circumferential direction of the lamp holder, the loading part 101 is located on the inner side of the blocking edge part 102, and the loading part 101 is designed to a square structure to conveniently mount the battery.

Three or four groups of locating sleeves 30 are provided, if four groups of locating sleeves are provided, the four groups of locating sleeves 30 are arranged in a square to form four supporting points, and if three groups of locating sleeves are provided, the three groups of locating sleeves 30 are arranged in a triangle to completely support the lamp holder 10.

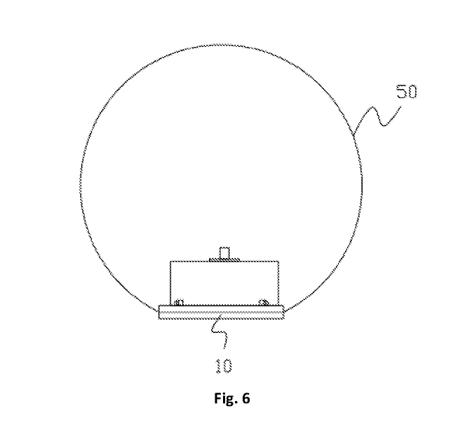

As shown in FIG. 6, an electronic lamp includes a lampshade 50, a circular mounting opening is formed in the bottom of the lampshade 50, a clamping edge is arranged on the edge of the mounting opening towards the interior of the lampshade, a lamp holder 10 is mounted in the mounting opening, an upper part of the lamp holder 10 protrudes upwards to form a loading part 101, a battery mounting bin 105 for mounting a battery is designed in the loading part 101, a bin cover 104 is arranged on the bottom surface of the lamp holder 10, and the bin cover 104 is used for covering the battery mounting bin 105; a luminous body 20 and a circuit board 201 and a button switch 202 used for controlling the luminous body 20 are arranged on the loading part 101; and the edge of the lamp holder 10 extends upwards to form a blocking edge part 102, the edge of the lamp holder 10 extends towards the outer side to form a blocking part 103, a cylindrical locating sleeve 30 is arranged on the blocking edge part 102, an axle hole penetrating through the locating sleeve 30 is formed in the middle of the locating sleeve 30, a notch 301 is formed in the outer side face of the locating sleeve 30, a locating piece 40 is arranged in the axle hole of the locating sleeve 30, and the locating piece 40 can rotate around the axle hole.

The lamp holder 10 is made of a plastic material or other lightweight insulating materials; and the shape of the lampshade 50 can be designed according to demands, the material can also be selected according to demands, for example, glass, ceramic, plastic, wood, metal or the like, as long as the requirements of the lampshade are satisfied, therefore the selection range is wide and the adaptability is good.

During assembly, the lamp holder 10 is directly clamped in the mounting opening in the bottom of the lampshade 50, the blocking edge part 102 is in contact with the inner wall of the lampshade 50, the blocking part 103 is propped on the bottom surface of the lampshade 50, at this time, the clamping stop dog 403 is located on the gap 302 at the upper part of the locating sleeve 30, the locating screw 401 is rotated clockwise, the locating screw 401 drives the locating cap 402 to rotate, when rotating to the notch 301 on the locating sleeve 30, the locating cap 402 drops off along the axle hole, the locating cap 402 is located by the limitation of the notch 301, so that the clamping stop dog 403 on the locating cap 402 is clamped on the clamping edge in the lampshade 50 to connect the lamp holder 10 with the lampshade 50, and then the clamping screw 401 is fastened; and during disassembly, the locating screw 401 is rotated counterclockwise, the locating screw 401 is partially separated from the locating cap 402, at this time, the locating cap 402 is jacked up to make the clamping stop dog 403 on the locating cap 402 be flush with the gap 302, the clamping stop dog is rotated counterclockwise to locate the clamping stop dog 403 on the gap 302 of the locating sleeve 30, so as to make the lamp holder 10 drop off relative to the lampshade 50, and then the lamp holder 10 can be taken off.

The basic principle and the main features of the utility model and the advantages of the utility model have been displayed and described above. Those skilled in the art should be aware that the utility model is not limited to the above embodiments, the above embodiments and the descriptions in the specification are merely used for illustrating the principle of the utility model, a variety of modifications and improvements can be made to the utility model without departing from the spirit or scope of the utility model, and these modifications and improvements shall fall into the protection scope of the utility model. The protection scope of the utility model is defined by the appended claims and the equivalents thereof.

1. An electronic lamp holder with an improved structure, comprising a lamp holder, an upper part of the lamp holder protrudes upwards to form a loading part, a battery mounting bin for mounting a battery is designed in the loading part, a bin cover is arranged on the bottom surface of the lamp holder, and the bin cover is used for covering the battery mounting bin; a luminous body and a circuit board and a button switch used for controlling the luminous body are arranged on the loading part; and the edge of the lamp holder extends upwards to form a blocking edge part, the edge of the lamp holder extends towards the outer side to form a blocking part, a cylindrical locating sleeve is arranged on the blocking edge part, an axle hole penetrating through the locating sleeve is formed in the middle of the locating sleeve, a notch is formed in the outer side face of the locating sleeve, a locating piece is arranged in the axle hole of the locating sleeve, and the locating piece can rotate around the axle hole.

2. The electronic lamp holder with an improved structure of claim 1, wherein a gap is formed in a position located on the left side of the notch on the upper edge opening of the locating sleeve, and protection edges integrated with the blocking edge part are arranged on both sides of the notch to combine the locating sleeve with the blocking edge part.

3. The electronic lamp holder with an improved structure of claim 1, wherein the locating piece comprises a locating screw, a locating cap is connected to an upper end of the locating screw, a clamping stop dog is arranged on the locating cap, and the clamping stop dog and the locating cap are vertical and are integrally formed; and a reinforcing rib is connected between the clamping stop dog and the locating cap.

4. The electronic lamp holder with an improved structure of claim 3, wherein the clamping stop dog can be clamped in the gap, the locating cap is inserted into the axle hole of the locating sleeve, the upper end of the locating screw penetrates through the lamp holder to stretch into the axle hole to be connected in the locating cap through threads, and a cross slotted head is arranged at a lower end of the locating screw.

5. The electronic lamp holder with an improved structure of claim 1, wherein the button switch is arranged on the bottom surface of the lamp holder, the button switch is connected with the circuit board, and the circuit board is connected with the battery.

6. The electronic lamp holder with an improved structure of claim 1, wherein the lamp holder is a circular lamp holder, the blocking edge part is arranged along the circumferential direction of the lamp holder, the loading part is located on the inner side of the blocking edge part, and the loading part is designed to a square structure.

7. The electronic lamp holder with an improved structure of claim 1, wherein four groups of locating sleeves are provided, and the four groups of locating sleeves are arranged in a square to form four supporting points.

8. The electronic lamp holder with an improved structure of claim 1, wherein three groups of locating sleeves are provided, and the three groups of locating sleeves are arranged in a triangle.

9. An electronic lamp, comprising a lampshade, a circular mounting opening is formed in the bottom of the lampshade, a clamping edge is arranged on the edge of the mounting opening towards the interior of the lampshade, a lamp holder is mounted in the mounting opening, an upper part of the lamp holder protrudes upwards to form a loading part, a battery mounting bin for mounting a battery is designed in the loading part, a bin cover is arranged on the bottom surface of the lamp holder, and the bin cover is used for covering the battery mounting bin; a luminous body and a circuit board and a button switch used for controlling the luminous body are arranged on the loading part; and the edge of the lamp holder extends upwards to form a blocking edge part, the edge of the lamp holder extends towards the outer side to form a blocking part, a cylindrical locating sleeve is arranged on the blocking edge part, an axle hole penetrating through the locating sleeve is formed in the middle of the locating sleeve, a notch is formed in the outer side face of the locating sleeve, a locating piece is arranged in the axle hole of the locating sleeve, and the locating piece can rotate around the axle hole.

10. The electronic lamp of claim 9, wherein the lamp holder is made of a plastic material or other insulating materials; and the material of the lampshade can be glass, ceramic, plastic, wood or metal.
